(19) United States
(12) Patent Application Publication
(10) Pub. No.: US 2018/0049061 A1
(43) Pub. Date: Feb. 15, 2018

(54) MEDIUM ACCESS CONTROL (MAC) HEADER COMPRESSION

(71) Applicant: QUALCOMM Incorporated, San Diego, CA (US)

(72) Inventors: Alfred ASTERJADHI, San Diego, CA (US); Maarten Menzo WENTINK, Naarden (NL); Simone MERLIN, San Diego, CA (US); George CHERIAN, San Diego, CA (US); Bin TIAN, San Diego, CA (US)

(21) Appl. No.: 15/725,659

(22) Filed: Oct. 5, 2017

Related U.S. Application Data
(62) Division of application No. 14/964,254, filed on Dec. 9, 2015.
(60) Provisional application No. 62/117,416, filed on Feb. 17, 2015.
(60) Provisional application No. 62/108,985, filed on Jan. 28, 2015.
(60) Provisional application No. 62/094,067, filed on Dec. 18, 2014.
(60) Provisional application No. 62/090,340, filed on Dec. 10, 2014.

(51) Int. Cl. H04W 28/06; H04L 29/06

(52) U.S. Cl. CPC H04W 28/065; H04L 69/04; H04W 28/06

(57) ABSTRACT

Certain aspects of the present disclosure provide an apparatus for wireless communications. The apparatus generally includes a processing system configured to generate a data frame based on a compressed data frame format and to include control information in at least one field of the data frame, wherein the at least one field is not specified in the compressed data frame format and an interface for outputting the data frame for transmission. Another example apparatus generally includes a processing system configured to generate a frame having a first one or more bits indicating whether the frame has a compressed format and a second one or more bits indicating which of one or more fields are absent if the frame has a compressed format and an interface for outputting the frame for transmission.

### CROSS-REFERENCE TO RELATED APPLICATIONS

The present Application for Patent is a Divisional of U.S. patent application Ser. No. 14/964,254, filed Dec. 9, 2015, which claims benefit of U.S. Provisional Patent Application Ser. No. 62/090,340, filed Dec. 10, 2014, U.S. Provisional Patent Application Ser. No. 62/094,067, filed Dec. 18, 2014, U.S. Provisional Patent Application Ser. No. 62/108,985, filed Jan. 28, 2015, U.S. Provisional Patent Application Ser. No. 62/117,416, filed Feb. 17, 2015, each assigned to the assignee hereof and hereby expressly incorporated by reference herein.

### BACKGROUND

### Field of the Disclosure

Certain aspects of the present disclosure generally relate to wireless communications and, more particularly, to medium access control (MAC) header compression, for example, for high efficiency wireless (HEW) frames.

### Description of Related Art

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique for communication systems. MIMO technology has been adopted in several wireless communications standards such as the Institute of Electrical and Electronics Engineers (IEEE) 802.11 standard. The IEEE 802.11 denotes a set of Wireless Local Area Network (WLAN) air interface standards developed by the IEEE 802.11 committee for short-range communications (e.g., tens of meters to a few hundred meters).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Aspects of the present disclosure generally relate to medium access control (MAC) header compression, for example, for high efficiency wireless (HEW) frames.

Certain aspects of the present disclosure provide an apparatus for wireless communications. The apparatus generally includes a processing system configured to generate a data frame based on a compressed data frame format and to include control information in at least one field of the data frame, wherein the at least one field is not specified in the compressed data frame format and an interface for outputting the data frame for transmission.

Certain aspects of the present disclosure provide another apparatus for wireless communications. The apparatus generally includes a processing system configured to generate a frame having a first one or more bits indicating whether the frame has a compressed format and a second one or more bits indicating which of one or more fields are absent if the frame has a compressed format and an interface for outputting the frame for transmission.

Certain aspects of the present disclosure provide a method for wireless communications. The method generally includes generating a data frame based on a compressed data frame format, including control information in at least one field of the data frame, wherein the at least one field is not specified in the compressed data frame format, and outputting the data frame for transmission.

Certain aspects of the present disclosure provide another method for wireless communications. The method generally includes generating a frame having a first one or more bits indicating whether the frame has a compressed format and a second one or more bits indicating which of one or more fields are absent if the frame has a compressed format and outputting the frame for transmission.

Certain aspects of the present disclosure provide an apparatus for wireless communications. The apparatus generally includes means for generating a data frame based on a compressed data frame format, means for including control information in at least one field of the data frame, wherein the at least one field is not specified in the compressed data frame format, and means for outputting the data frame for transmission.

Certain aspects of the present disclosure provide another apparatus for wireless communications. The apparatus generally includes means for generating a frame having a first one or more bits indicating whether the frame has a compressed format and a second one or more bits indicating which of one or more fields are absent if the frame has a compressed format and means for outputting the frame for transmission.

Certain aspects of the present disclosure provide a computer program product. The computer program product generally includes comprising a computer readable medium having instructions stored thereon for generating a data frame based on a compressed data frame format, including control information in at least one field of the data frame, wherein the at least one field is not specified in the compressed data frame format, and outputting the data frame for transmission.

Certain aspects of the present disclosure provide a computer program product. The computer program product generally includes comprising a computer readable medium having instructions stored thereon for generating a frame having a first one or more bits indicating whether the frame has a compressed format and a second one or more bits indicating which of one or more fields are absent if the frame has a compressed format and outputting the frame for transmission.

Certain aspects of the present disclosure provide a station. The station generally includes at least one antenna, a processing system configured to generate a data frame based on a compressed data frame format and to include control information in at least one field of the data frame, wherein the at least one field is not specified in the compressed data frame format, and a transmitter configured to transmit the data frame via the at least one antenna.

Certain aspects of the present disclosure provide a station. The station generally includes at least one antenna, a processing system configured to generate a frame having a first one or more bits indicating whether the frame has a compressed format and a second one or more bits indicating which of one or more fields are absent if the frame has a compressed format, and a transmitter configured to transmit the frame via the at least one antenna.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 illustrates an example wireless communications network, in accordance with certain aspects of the present disclosure.

FIG. 2 is a block diagram of an example access point (AP) and user terminals, in accordance with certain aspects of the present disclosure.

FIG. 3 is a block diagram of an example wireless device, in accordance with certain aspects of the present disclosure.

FIG. 4 illustrates an example uplink (UL) downlink (DL) multiple user (MU) frame exchange.

FIG. 5 illustrates an example protocol version 0 medium access control (MAC) protocol data unit (MPDU), in accordance with certain aspects of the present disclosure.

FIG. 6 illustrates an example protocol version 1 MPDU, in accordance with certain aspects of the present disclosure.

FIG. 7 illustrates an example control frame with trigger information, in accordance with certain aspects of the present disclosure.

FIG. 8 illustrates an example HE Control frame format, in accordance with certain aspects of the present disclosure.

FIG. 9 illustrates an example MPDU delimiter with bits to indicate presence or absence of fields in a MPDU, in accordance with certain aspects of the present disclosure.

FIG. 9A is a table illustrating a mapping of the bits to presence or absence of fields in the MPDU, in accordance with certain aspects of the present disclosure.

FIG. 9B illustrates an example reduced PV1 frame, in accordance with certain aspects of the present disclosure.

FIG. 9C illustrates an example reduced PV1 frame, in accordance with certain aspects of the present disclosure.

FIG. 10 is a flow diagram of example operations for wireless communications, in accordance with certain aspects of the present disclosure.

FIG. 10A illustrates example means capable of performing the operations shown in FIG. 10.

FIG. 11 is a flow diagram of example operations for wireless communications, in accordance with certain aspects of the present disclosure.

FIG. 11A illustrates example means capable of performing the operations shown in FIG. 11.

FIG. 12 illustrates example fields of a frame control field included in a wrapped PV1 frame, in accordance with certain aspects of the present disclosure.

FIG. 13 is a flow diagram of example operations for wireless communications, in accordance with certain aspects of the present disclosure.

FIG. 13A illustrates example means capable of performing the operations shown in FIG. 13.

FIG. 14 illustrates an example frame having MAC information in the PHY header, in accordance with certain aspects of the present disclosure.

FIG. 15 is a flow diagram of example operations for wireless communications, in accordance with certain aspects of the present disclosure.

FIG. 15A illustrates example means capable of performing the operations shown in FIG. 15.

FIG. 16 illustrates an example frame having a null frame with MAC information in the first frame of an A-MPDU, in accordance with certain aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects of the present disclosure generally relate to physical (PHY) layer medium access control (MAC) layer signaling, such as providing an immediate response allocation with indication in 11 ax PHY header. According to certain aspects, a station may send a data frame (e.g., an MPDU) based on a compressed data frame format (e.g., a short frame) that includes an additional field (e.g., an HE Control field) with control information. According to certain aspects, stations may send a frame having a first one or more bits (e.g., in Bit 1 of the MPDU delimiter) indicating whether the frame has a compressed format and a second one or more bits (e.g., 2 MSBs of the MPDU Length field of the MPDU delimiter) indicating which of one or more fields are absent if the frame has a compressed format.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting and the scope of the disclosure is being defined by the appended claims and equivalents thereof.

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, Radio Network Controller (“RNC”), evolved Node B (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the AT is a wireless node. Such wireless node may provide, for example, connectivity for or to a network (e.g., a wide area network such as the Internet or a cellular network) via a wired or wireless communication link.

### An Example Wireless Communication System

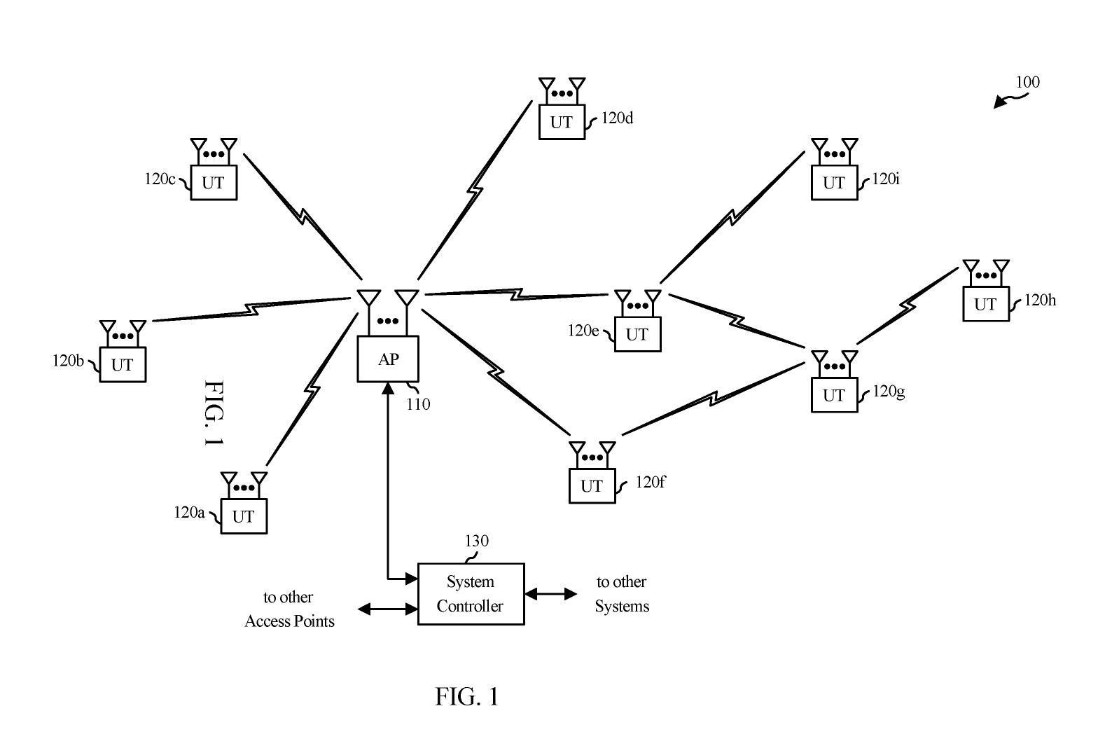

FIG. 1 illustrates a system 100 in which aspects of the disclosure may be performed. For example, the access point 110 may send user terminals 120 a data frame (e.g., an MPDU) based on a compressed data frame format (e.g., a short frame) that and includes control information in at least one field (e.g., an HE Control field). In another example, the access point 110 may send user terminals 120 a frame having a first one or more bits (e.g., in the MPDU delimiter) indicating whether the frame has a compressed format and a second one or more bits (e.g., 2 MSBs of the MPDU Length field of the MPDU delimiter) indicating which of one or more fields are absent if the frame has a compressed format. In another example, the one or more bits can be included in the frame itself.

The system 100 may be, for example, a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal.

A system controller 130 may provide coordination and control for these APs and/or other systems. The APs may be managed by the system controller 130, for example, which may handle adjustments to radio frequency power, channels, authentication, and security. The system controller 130 may communicate with the APs via a backhaul. The APs may also communicate with one another, e.g., directly or indirectly via a wireless or wireline backhaul.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

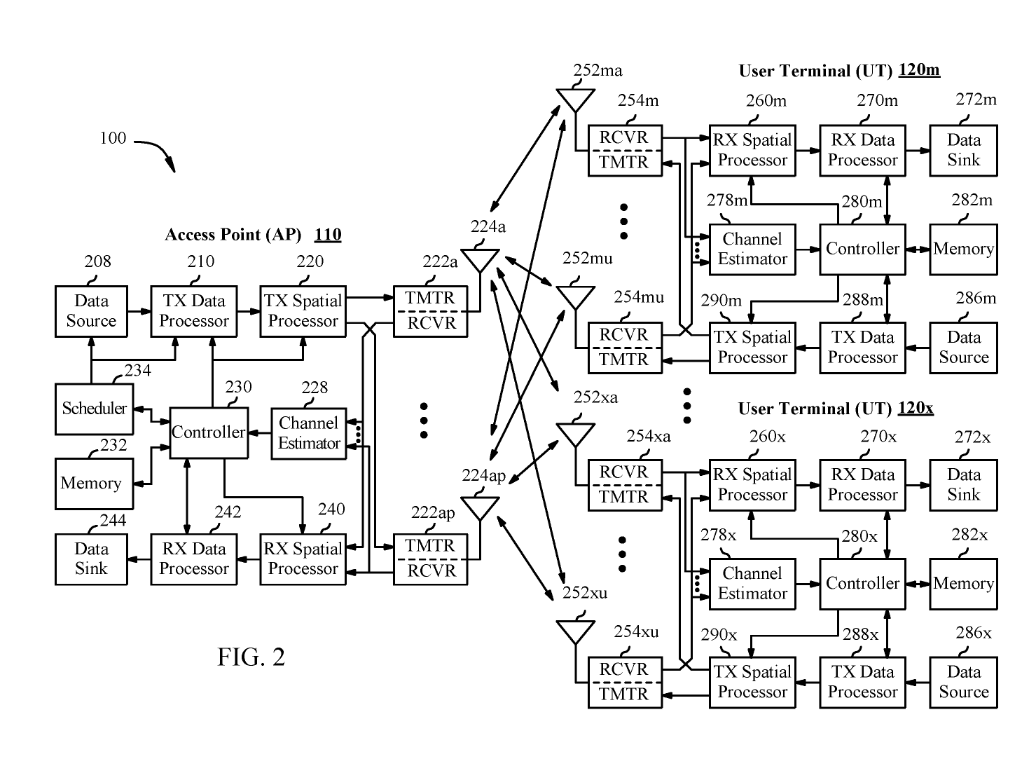

FIG. 2 illustrates a block diagram of a system 100 in which aspects of the present disclosure may be performed. For example, the access point 110 may send user terminals 120 a data frame (e.g., an MPDU) based on a compressed data frame format (e.g., a short frame) that and includes control information in at least one field (e.g., an HE Control field). In another example, the access point 110 may send user terminals 120 a frame having a first one or more bits (e.g., in the MPDU delimiter) indicating whether the frame has a compressed format and a second one or more bits (e.g., 2 MSBs of the MPDU Length field of the MPDU delimiter) indicating which of one or more fields are absent if the frame has a compressed format. In another example, the one or more bits can be included in the frame itself.

The system 100 may be, for example, a MIMO system with access point 110 and two user terminals 120m and 120x. The access point 110 is equipped with Nₜ antennas 224a through 224ap. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nᵤₚ user terminals are selected for simultaneous transmission on the uplink, N_{dn} user terminals are selected for simultaneous transmission on the downlink, Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals. The decoded data for each user terminal may be provided to a data sink 272 for storage and/or a controller 280 for further processing.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, SNR estimates, noise variance and so on. Similarly, at access point 120, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

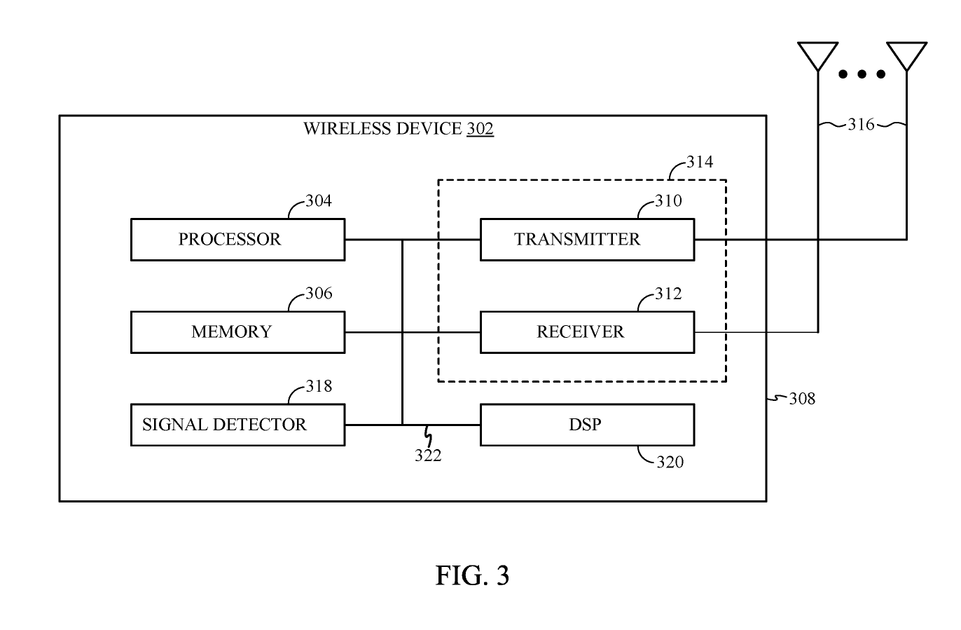

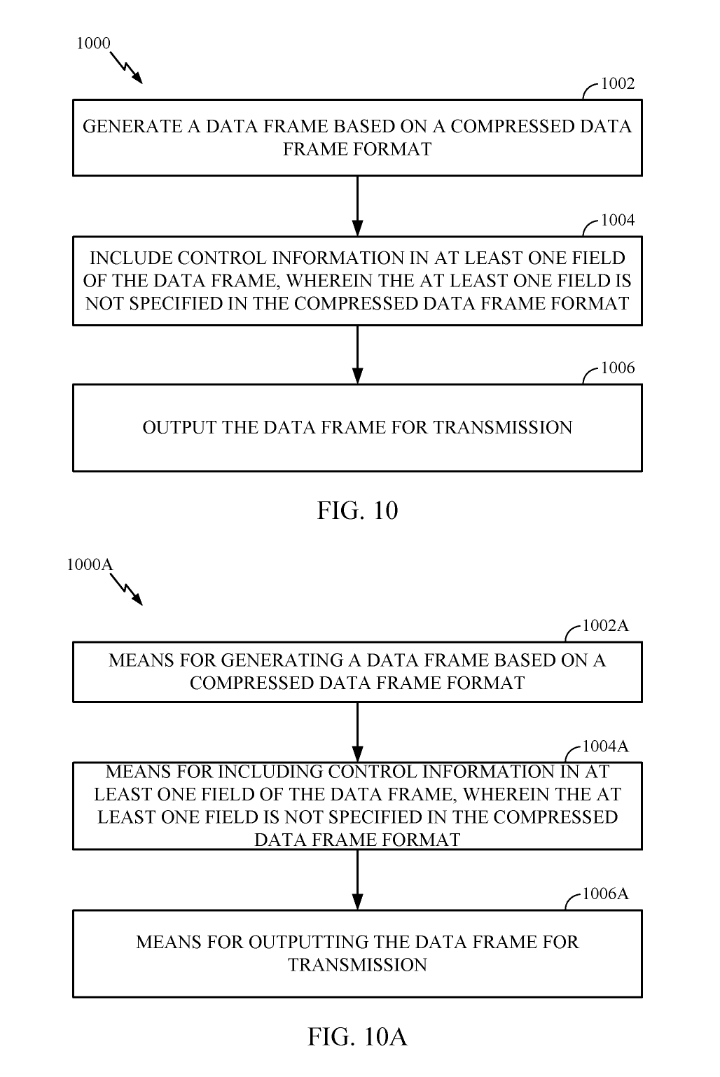

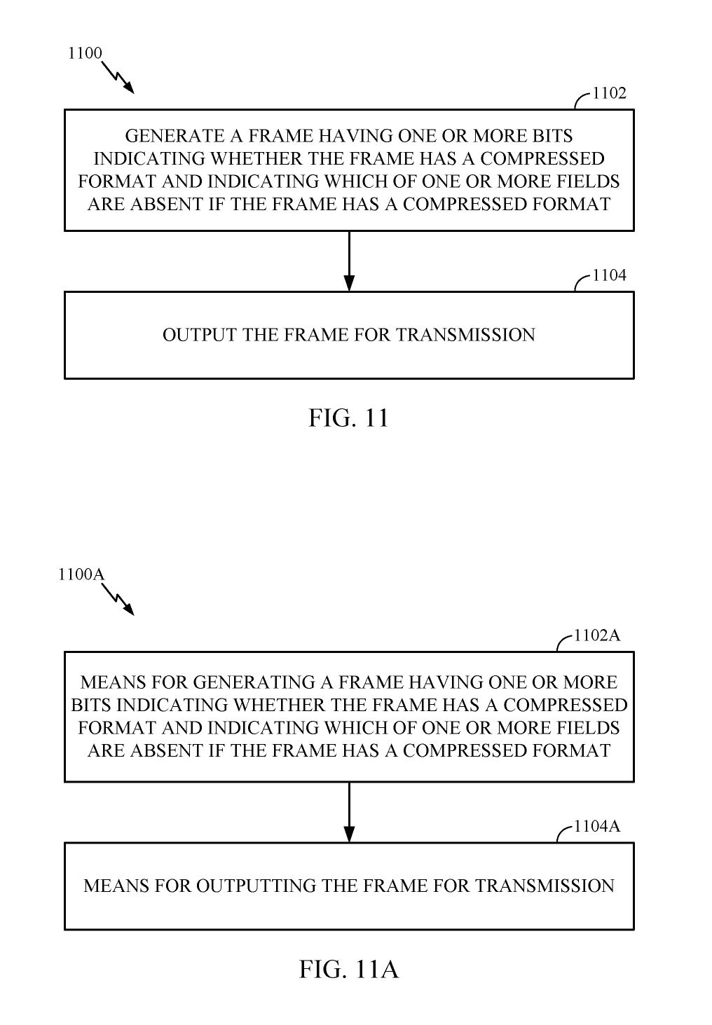

FIG. 3 illustrates various components that may be utilized in a wireless device 302 that may be employed within the MIMO system 100. The wireless device 302 is an example of a device that may be configured to implement the various methods described herein. For example, the wireless device may implement operations 1000 and 1100 illustrated in FIGS. 10 and 11, respectively. The wireless device 302 may be an access point 110 or a user terminal 120.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote node. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

### Example MAC Header Compression

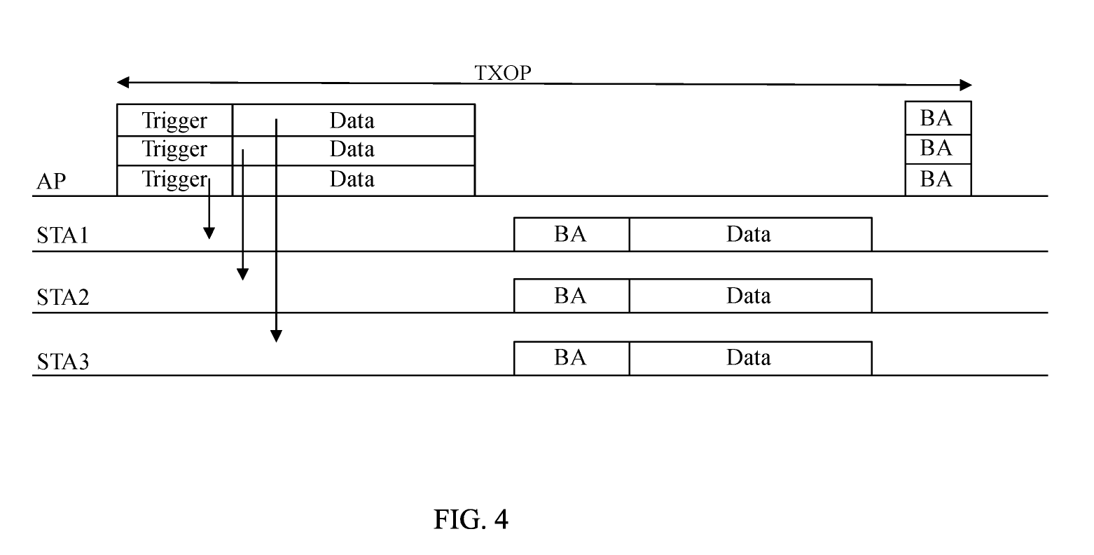

For multiple user (MU) operations, low data rates (e.g., 750 kbps) may be used. FIG. 4 illustrates an example uplink (UL) downlink (DL) frame exchange in MU operations. As shown in FIG. 4, an access point (AP) may transmit a trigger frame aggregated with data (e.g., as part of an aggregated medium access control (MAC) protocol data unit (A-MPDU) addressed to the same STA) on the downlink to a number of stations (STAs) STA1, STA2, and STA3, etc. The downlink frame may solicit an immediate response (e.g., a block acknowledgment (BA), acknowledgement (ACK), etc.) from one or more of the stations and/or schedule the stations for sending uplink data. For example, the trigger frame may include control information such as the UL resource allocation, modulation coding scheme (MCS), etc. On the uplink, the stations may use the allocated resources to each send, for example, BA frames aggregated with data, wherein the BA frames acknowledge the data received from the AP. The AP may then respond with BA for each STA on the downlink to acknowledge the UL data. As shown in FIG. 4, in both the uplink and downlink directions, In other words, a control frame (e.g., a trigger frame, BA frame, ACK frame, etc.) is aggregated with one or more data frames and are transmitted as an A-MPDU.

MAC signaling overhead may increase with low data rate and/or reduced air times. MAC signaling overhead may also increase with an increased number MAC frame exchanges (signaling frequency), such as by increasing the number of MPDUs exchanged during air time and/or increasing MAC signaling within an MPDU. Thus, for MU operations, MAC signaling overhead may be increased since the AP may be signaling multiple STAs simultaneously.

Accordingly, techniques for reducing MAC signaling overhead are desirable.

According to certain aspects of the present disclosure, techniques are provided herein for removing redundant/unnecessary overhead due to protocol signaling for short packet at the physical layer protocol data unit (PPDU), MPDU, and A-MPDU level. Aspects of the present disclosure provide for PHY signaling in a PPDU, decoupled from MAC signaling, which allocates PHY resources for an immediate response and carrying a MAC payload in the immediate response PHY resources.

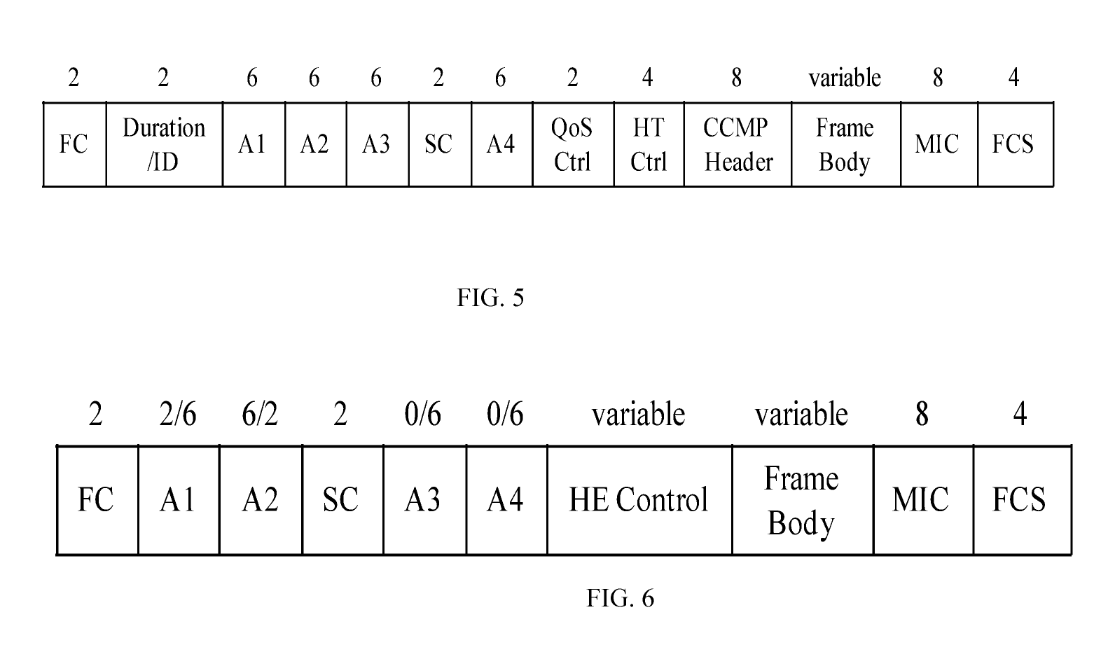

According to certain aspects, header compression may be performed to reduce signaling overhead at the MPDU level. FIG. 5 illustrates an example protocol version 0 MPDU, in accordance with certain aspects of the present disclosure. FIG. 6 illustrates an example protocol version 1 (short frame) MPDU, in accordance with certain aspects of the present disclosure. According to certain aspects, PV1 frame format may have less overhead than the PV0 frame format. According to certain aspects, PV1 MPDUs may have a minimum MAC overhead of 16 Bytes (or 24 Bytes with security) instead of a minimum MAC overhead of 30 Bytes (46 Bytes with security) of a PV0 MPDU. Thus, for PV1 frames, per-MPDU MAC overhead may be reduced by 16 Bytes (or 22 Bytes with security). An additional control field (e.g., a high efficiency (HE) Control field) may be added to the PV0 or PV1 frame structure in order to provide certain control information. For example, although not shown in FIG. 5, the HT field may be used as the HE Control field and may be of variable length so that to contain the various control information provided by control frames. As shown in FIG. 6, a variable length HE Control field may be added to the PV1 frame format. According to certain aspects, a payload field may be defined and may be added to control frames in order to carry the payload content of data of a data frame or quality of service (QoS) data frame.

According to certain aspects, overhead reduction may be performed at the A-MPDU level.

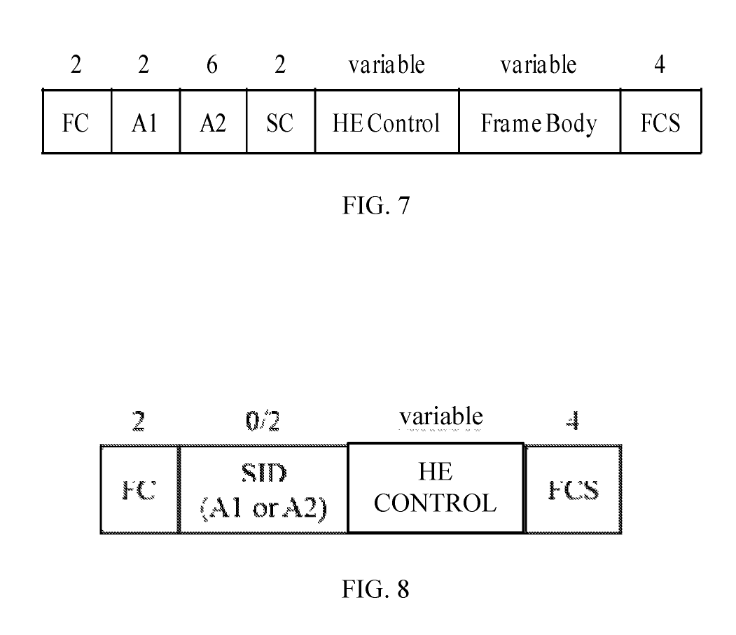

As described above with reference to FIG. 4, on the DL, the AP may transmit a frame with trigger information and data to stations STA1, STA2, STA3. Generally, if a control frame is appended in an A-MPDU this happens to be always the first MPDU. According to certain aspects, as shown in FIG. 7, the AP may transmit a wrapped version of the first two MPDUs. Data and Control wrapping may be sufficient to carry the control information, rather than sending the control frame and the data frame as two independent MPDUs. According to certain aspects, the control information (e.g., trigger info) may be wrapped in the Data frame as a Data+Control frame (e.g., Data+Trigger frame). As shown in FIG. 7, the control information may be included in a field (e.g., the HE Control field) that is contained in a compressed Data frame (e.g., a PV1 with some fields absent).

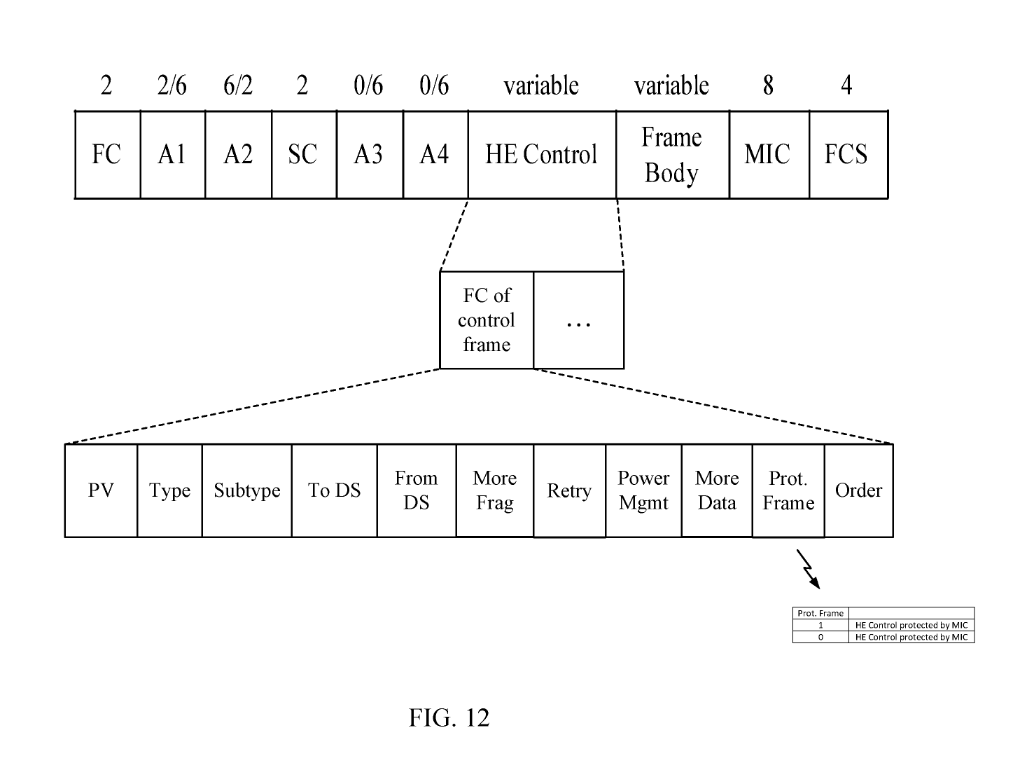

In certain aspects, the HE Control field that is included in the PV0 frame or PV1 frame as described above may include the Frame Control field of the Control frame the control information of which the HE Control field is carrying (see FIG. 12). As an example, the Frame Control field that is contained in the HE Control field may indicate that the information contained is that of a BlockAck frame (i.e., the type field of the frame control field indicates a control frame and the subtype field indicates a BlockAck frame). As a result the remaining portion of the HE Control field may contain the control information that is carried by this type of frame for example the BlockAck Control field, the Starting Sequence Control field, and the BlockAck Bitmap field (i.e., when the HE Control field contains BlockAck control information it may consist of one or more of the following fields (Frame Control, Block Ack Control, Starting Sequence Control, Block Ack Bitmap). In general, the HE Control field may carry the control information of any type of control frame (excluding the Duration, A1, A2 and FCS fields of the Control frame). In certain aspects, the HE Control field may carry certain information elements that would have been included in management frames, i.e., it may act as a carrier of management information. One or more fields of the HE control field may indicate the different combinations.

According to certain aspects, the control field may contain the frame control (FC) field of the control frame and may contain additional information depending on the FC field subtype value. For example, if the FC field subtype value indicates a trigger, the control field may also contain the STA info field to indicate which STAs are the intended recipients and requested to respond. Alternatively, if the FC field subtype value indicates BlockAck, the control field may also include the BA Control field, Starting Sequence Control (SSC) field, and BlockAck Bitmap field. Thus, as shown in FIG. 7, the STAs may respond with a wrapped frame which can contain a Data+BA, upon reception of which the AP may then respond with BA. For the Ack frame, its presence is not needed because the frame itself would indicate successful acknowledgement. In another implementation, the presence of the Frame Control field may be sufficient to identify the Ack frame. According to certain aspects, the Frame Control field may be reduced to 1 Octet in length and may contain only part of its subfields (e.g., not contain one or more of the protocol version field, type field, from DS (Distribution System), To DS, more fragments, retry, etc as these fields are generally set to predefined values in Control frames).

According to certain aspects, the HE Control field may carry certain information elements that would have been included in management frames, i.e., it may act as a carrier of management information. One or more fields of the HE control field may indicate the different combinations.

According to certain aspects, the HE control field may include the information of a control frame or management frame, however, certain fields of the control or management frame may be absent, for example, such as the A1 field, the A2 field, the Duration/ID field, and/or the FCS field. According to certain aspects, a newly defined frame may carry one or more portions of the HE Control field. According to certain aspects, the newly defined frame may be a PV0 frame or a PV1 frame. The newly defined frame may carry portions of the HE Control field and may be a frame of any type, such as a control frame, a management frame, a data frame, or an extended frame (i.e., the type subfield of the frame control field of the newly defined frame may be set to any value). In an example implementation, the control frame or management frame fields absent in the newly defined frame may include at least one of the following fields: Duration field, A1 field, A2 field; however, the HE Control field may be present in the newly defined frame. According to certain aspects, the newly defined frame may be a PV1 HE Control frame. Alternatively, the newly defined frame may be a PV0 HE Control frame. In another example implementation, the newly defined frame may contain either of the A1 or A2 fields that contains at least a portion of the AID of the transmitting STA or receiving STA as specified in the Frame Control field of the newly defined frame. According to certain aspects, the A1 or A2 fields may contain an identifier copied from the immediately previously received frame that elicited the current HE control frame. According to certain aspects, the presence of the A1 or A2 field may be signaled by setting one or more subfields of the Frame Control field of newly defined frame to a non-zero value.

FIG. 8 illustrates an example HE Control frame format, in accordance with certain aspects of the present disclosure. As discussed above, the HE Control frame format may be PV0 or PV1 frame format. According to certain aspects, the HE Control frame may be carried in an A-MPDU along with PV1 MPDUs and/or PV0 MPDUs. According to certain aspects, more than one HE Control frame may be carried in the A-MPDU, each HE Control frame being addressed to one or more STAs, for example, when the A-MPDU is addressed to one or more STAs. The A-MPDU frame may be transmitted as a single user (SU) transmission or as a multi user (MU) transmission. The transmissions may be either DL or UL and may use either OFDMA or MIMO.

According to certain aspects, applying the above techniques, for two MPDUs, wrapped control information and data may be sent to the multiple STAs without using the A-MPDU format. Thus, the A-MPDU format overhead (greater than 8 bytes) may be removed as well as much of the MAC overhead of a control frame (e.g., 18 Bytes from Trigger (Duration (2B), A1 (6B), A2(6B), FCS(4))).

In certain cases, it may be beneficial to aggregate multiple short packets in an A-MPDU (more than two MPDUs), for example, to exploit robustness provided by the frame check sequence (FCS) field or to aggregate fragments of an MPDU, etc.

According to certain aspects, indicators in the MPDU delimiter may be used to indicate presence or absence of one or more fields in each of the MPDU that follow the MPDU delimiter.

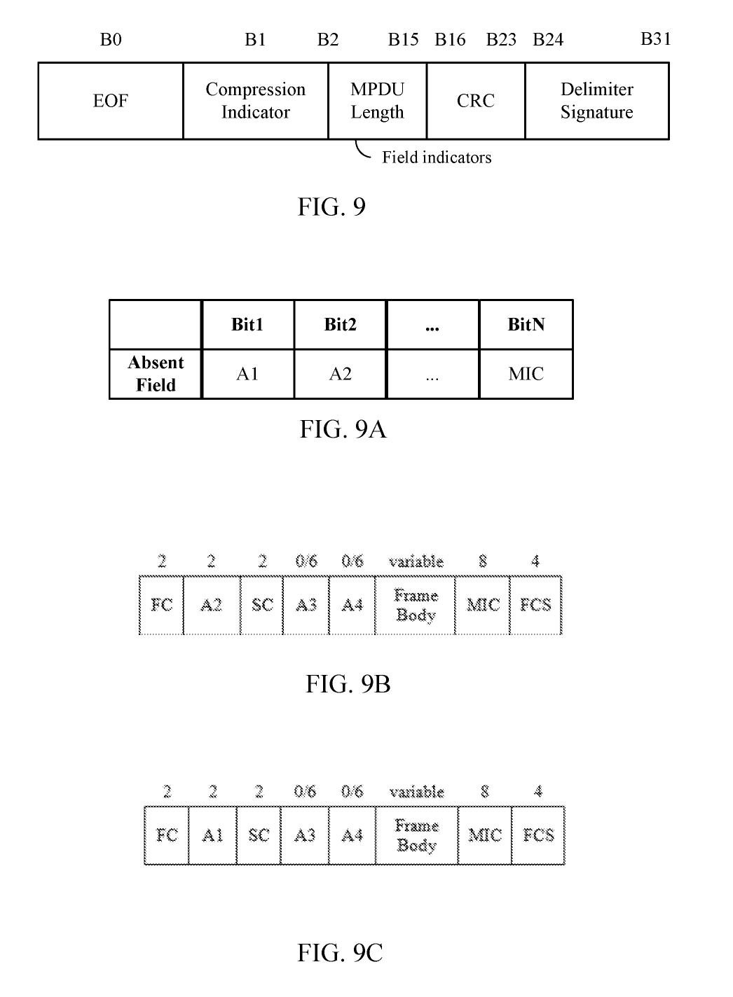

FIG. 9 illustrates an example MPDU delimiter with bits to indicate presence or absence of fields in a MPDU, in accordance with certain aspects of the present disclosure. According to certain aspects, a Compression Indicator field may be included in the MPDU delimiter. For example, a bit (e.g., B1) in the MPDU delimiter may indicate whether or not one or more of the Duration/ID field, Address 1 field, and Address 2 field, Address 3 field, are present wherein the particular field presence is indicated by additional signaling that is indicated as described below. For example, a value of the bit set to 0 may indicate that all the fields of the MPDU are present and a value of the bit set to 1 may indicate that certain fields of the MPDU that follows the MPDU delimiter are absent wherein the presence and/or absence of a particular field is signaled in an another field of the MPDU delimiter as described below.

According to certain aspects, additional signaling in the MPDU delimiter may indicate which are fields are not present when the Compression Indicator field have a value set to 1 to indicate that fields are absent. For example, the additional signaling may be contained in the MPDU Length field of the delimiter. In an example implementation, when the Compression Indicator field has a value of 1, then two or more most significant bits (MSBs) of the MPDU Length field may be overloaded to signal Compression Control if certain fields are the same throughout the A-MPDU (e.g., the same as the first MPDU). For example, one bit (value) may indicate Address 1 field, Address 2 field, or Duration/ID field (or other field) is not present as its value is identical across all MPDUs of the A-MPDU. In another example, one bit (value) may indicate that Address 3, and/or Address 4 are not present as its value is identical across all MPDUs of the A-MPDU.

According to certain aspects, a common value of the MIC field may be defined across all fragments and included in the A-MPDU. According to certain aspects, a bit in the MPDU Length field may signal the presence or absence of the MIC fields for all the MPDUs except for one of the MPDUs (e.g., the first MPDU) that are included in the A-MPDU.

According to certain aspects, the compression techniques utilizing control and data wrapping described herein may lead to reduced overhead on the uplink and the downlink, and may apply to secure and non-secure frames as well as different frame formats such as PV0 or PV1.

In an example implementation, without using compression, a non-secure downlink A-MPDU transmission using PV0 frame may include a 24 byte trigger frame (e.g., a 2 byte FC field, a 2 byte duration field, a 6 byte A1 field, a 6 byte A2 field, and 4 byte FCS and 4 byte STA info field) and a 30 byte data frame (e.g., a 2 byte FC field, a 2 byte duration field, a 6 byte A1 field, a 6 byte A2 field, a 6 byte A3 field, a 2 byte sequence control field, a 2 byte QoS Control field, and 4 byte Payload and FCS field) for a total 54 bytes. An uplink A-MPDU transmission may be similar in content except that the control frame that precedes the UL Data frame is a BlockAck frame which contains BlockAck Control/Starting Sequence Control, and BlockAck Bitmap field instead of the STA info field that is contained in a trigger frame. The total bytes for UL/DL non-secure transmissions in A-MPDUs without compression may be 116 bytes. By removing the duration field, A1 field, and A2 field in the data frame on the downlink, and removing the duration field, A1 field, and A2 field in the data frame and the control frame on the uplink, the total overhead may be reduced 74 bytes, or a 42 byte reduction. For secure transmissions, which may use additional bytes for the fields, total overhead may be reduced from 148 bytes to 106 bytes for a reduction of 42 bytes.

In another example implementation, without using compression, a non-secure downlink transmission using PV1 may include a 18 byte control frame (e.g., a 4 byte delimiter, a 2 byte FC field, a 2 byte A1 field, a 6 byte A2 field, and 4 byte FCS and STA info field) and a 20 byte data frame (e.g., a 4 byte delimiter, a 2 byte FC field, a 2 byte A1 field, a 6 byte A2 field, a 2 byte SC field, a 2 byte qc field, and 4 byte pyld and FCS field) for a total 38 bytes. An uplink transmission may be the same except with a BAC/SSC, BAB field instead of the STA info field. The total bytes for UL/DL non-secure transmissions without compression may be 76 bytes. By wrapping the control and data frame, the total overhead may be reduced to 42 bytes, a 34 byte reduction. On the downlink the wrapped PV1 control and data frame may include 4 byte delimiter, 2 byte FC field, 2 byte A1 field, 6 byte A2 field, 1 byte HE control field which may contain the STA info, a 2 byte SC field, and a 4 byte FCS field. The uplink transmission may again be the same except with the BAC/SSC, BAB field instead of the STA info field. For secure transmissions, which may use additional bytes for the fields, total overhead may be reduced from 92 bytes to 58 bytes for a reduction of 34 bytes. Additionally to using a wrapped PV1 frame format, the delimiter field may be absent in both the uplink and the downlink. In this case, the total overhead reduction may be 42 bytes for non-secured transmissions and 42 bytes for secured transmissions. A compressed wrapped PV1 frame may have even further reduced overhead by further removing the remaining downlink A1 and A2 fields. In this case, the total overhead may be reduced by 50 bytes for non-secured transmissions and 50 bytes for secured transmissions.

Generally the PV1 frame format may include an A1 field (containing the receiver address) and an A2 field (containing the transmitter address). However, as noted above, if further compression is desired, the A1 field and/or the A2 field, containing a MAC address, may be removed.

For example, according to certain aspects, the combination of a bit in the From DS field of the frame control field and another bit in the frame control field may indicate the presence or absence of at least the A1 field or the A2 field. For example, when the From DS field of the Frame Control field of the PV1 frame is set to 0, indicating that the frame is transmitted by a non-AP STA to an AP or by a non-AP STA to another non-AP STA (e.g., indirect link), and a bit in the PV1 frame (e.g., bit B15) is set to 1 it may indicate that the A1 field is not present in the frame, as shown in FIG. 9B. Otherwise, if the other bit of the Frame Control field (e.g., B15) is set to 0 it may indicate that the A1 field is present in the frame.

According to certain aspects, if the A1 field, containing the receiving address of the frame (i.e., the MAC address), is removed from the frame the intended receiver of the frame may identify that the frame is intended for it according to the teachings herein

According to certain aspects, when the From DS field of the FC field of the PV1 frame is set to 1, indicating that the frame is transmitted by an AP to a non-AP STA, and the other bit in the PV1 frame (e.g., bit B15) is set to 1, it may indicate that the A2 field is not present in the frame, as shown in FIG. 9C. Otherwise, if the other bit of the Frame Control field (e.g., B15) is set to 0 it may indicate that the A2 field is present in the frame.

According to certain aspects, when the A2 field that contains the transmitting address of the frame (i.e., the MAC address) is removed from the frame, the intended receiver of the frame may be identified by the transmitter of the frame according to the teachings herein.

Another example technique to further compress a wrapped PV1 frame may be to reduce the bits in the A1 and/or A2 fields. For example, according to certain aspects, the A1 or A2 field, both of which may be 2 Octets long, may contain an AID field which is 11 bits long and it may populate bits from B0 to B10 of the SID field unlike the baseline PV1 frame that contains a 13 bit long AID. Under this example, the extra 2 bits may be used for additional signaling. For example, one or more of the bits may be used to indicate that the PV1 frame is a wrapped frame as described above. In some cases, the one or more of the bits may indicate that the content of the AID field are overloaded with additional information. For example the transmitter may include in the AID field the size of its buffers or queues for a given Traffic Class or Traffic Stream and other information such as its buffer status. In general, any information that is contained in the QoS Control field of a PV0 frame (i.e., an MPDU for which the protocol version field is 0) may be included in this portion of the field.

FIG. 10 is a flow diagram of example operations 1000 for wireless communications, in accordance with certain aspects of the present disclosure. The operations 1000 may be performed, for example, a station (e.g., AP 110 or user terminal 120). The operations 1000 may begin, at 1002, by generating a data frame (e.g., an MPDU) based on a compressed data frame format (e.g., PV1).

At 1004, the STA may include control information in at least one field (e.g., the FC field) of the data frame, wherein the at least one field is not specified in the compressed data frame format. According to certain aspects, the control information may be designed to solicit a response from a device. According to certain aspects, the at least one field may include at least one other field (e.g., BA control field, SSC field, or BA bitmap field) if a subtype field of the FC field has a particular value (e.g., indicating BA).

At 1006, the STA may output the data frame for transmission.

FIG. 11 is a flow diagram of example operations 1100 for wireless communications, in accordance with certain aspects of the present disclosure. The operations 1100 may be performed, for example, a station (e.g., AP 110 or user terminal 120). The operations 1100 may begin, at 1102, by generating a frame having one or more bits indicating whether the frame has a compressed format and indicating which of one or more fields are absent if the frame has a compressed format. In some cases, the one or more bits may include a first one or more bits (e.g., in the MPDU delimiter) indicating whether the frame has a compressed format and a second one or more bits (e.g., in the same or a different field of the delimiter) indicating which of one or more fields are absent if the frame has a compressed format. According to certain aspects, each of the second one or more bits may indicate absence of a field in the frame if the frame the compressed format. According to certain aspects, at least one of the second one or more bits may indicate absence of a message integrity check (MIC) field.

At 1104, the STA may output the frame for transmission.

### Example Delivery of Common MAC Information

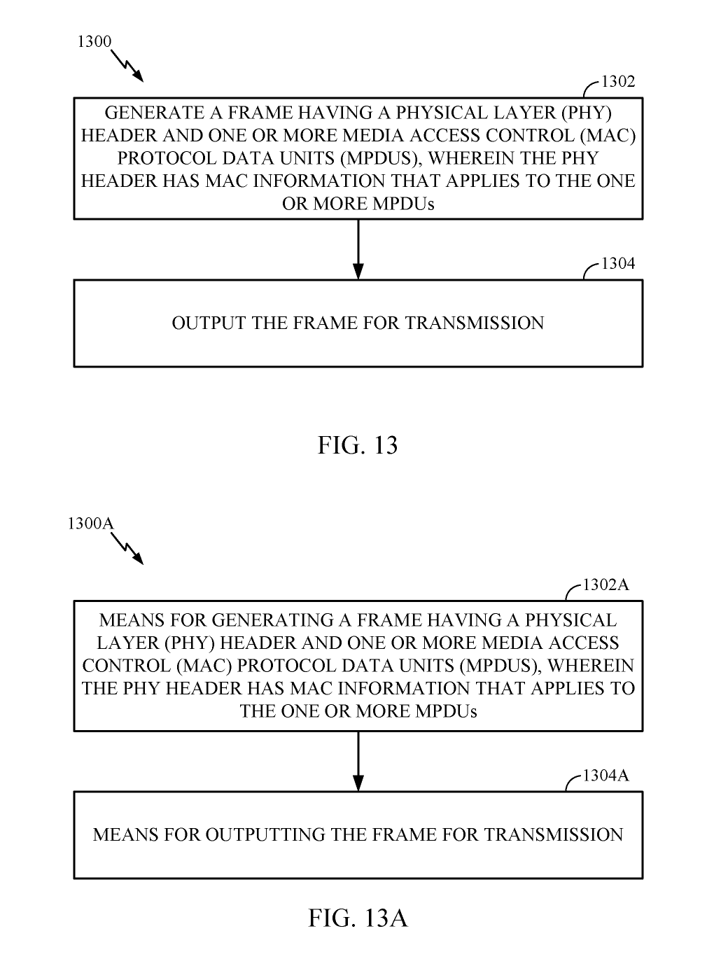

According to certain aspects, MAC information common to one or more MPDUs in a frame may be conveyed in the PHY header of the frame. FIG. 13 illustrates example operations that may be performed, for example, by an access point for conveying common MAC information in a PHY header. At 1302, the AP generates a frame having a physical layer (PHY) header and one or more media access control (MAC) protocol data units (MPDUs), wherein the PHY header has MAC information that applies to the one or more MPDUs. At 1304, the AP outputs the frame for transmission.

In some cases, the common MAC information, for example, information removed from the MAC headers (as described in previous aspects) of the MPDUs, may be included in the PHY header (e.g., in a PLCP) of the frame. In the previously discussed embodiments the common MAC information that is included in the A-MPDUs can be one or more of the following fields, Frame Control, Duration/ID field, A1, A2, A3, A4, QoS Control fields.

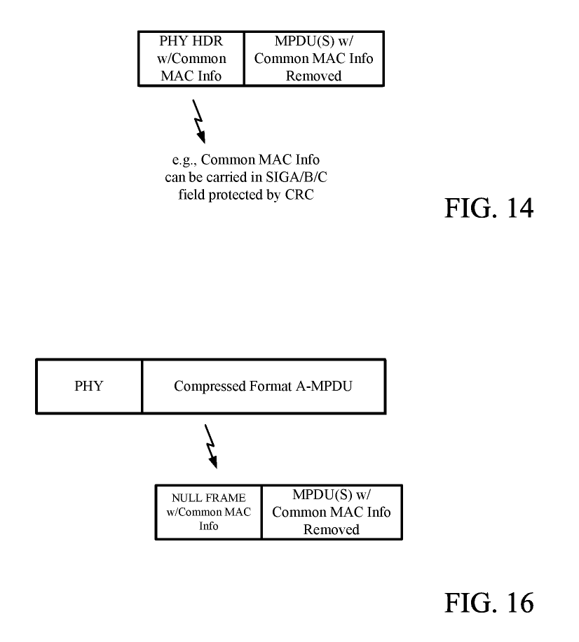

As illustrated in FIG. 14, in an example implementation, one or more of the common MAC information may be included in the SIG-A field, SIG-B field, and/or SIG-C field (or other type signal field). In this case, the common MAC information may be protected by the CRC of these fields (the length of the CRC field can be 4, 8, 16 or 32 bits in length depending on what level of protection can be defined by the cyclic redundancy checks (CRCs) of the PHY). According to certain aspects, the SIG-A field, SIG-B field, and/or SIG-C field may also include an aggregation bit that indicates whether aggregation is applied in the PSDU that is carried by the frame (e.g., a “1” to indicate an A-MPDU is carried in the PSDU or a “0” to indicate that an MDPU is carried in the PSDU, located therein). The common MAC information is subsequently removed from one or more of the MPDUs that are included in the one or more of the A-MPDUs that are transmitted during the TXOP.

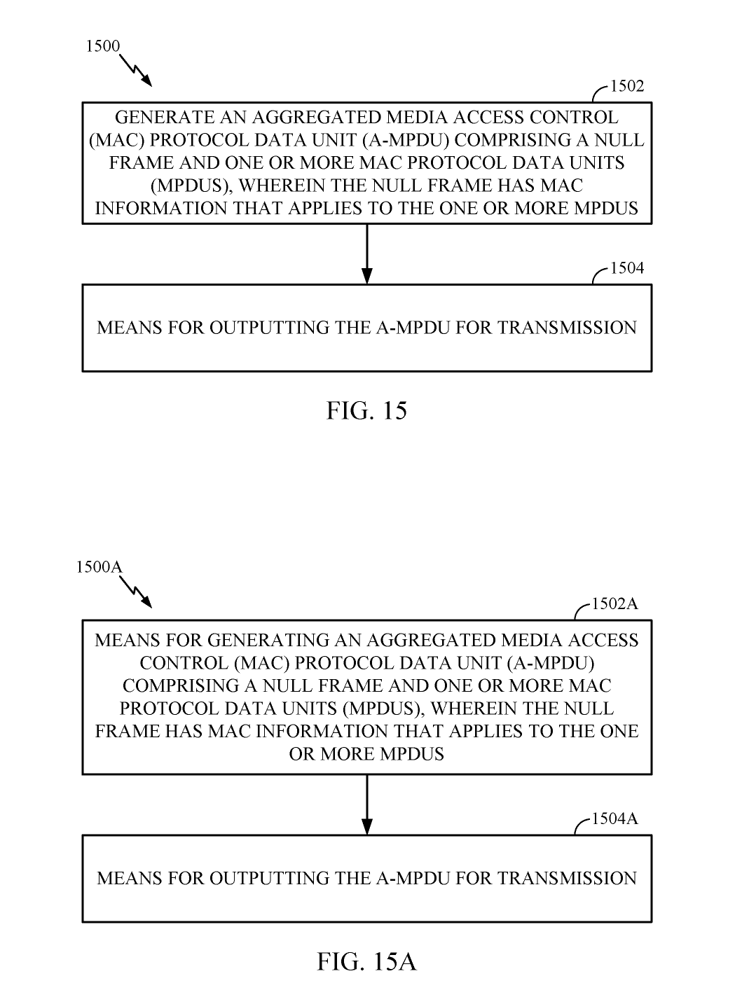

According to certain aspects, MAC information common to one or more MPDUs in a frame may be conveyed in a NULL frame PHY header of the frame. FIG. 15 illustrates example operations that may be performed, for example, by an access point for conveying common MAC information in a NULL frame. At 1502, the AP generates an aggregated media access control (MAC) protocol data unit (A-MPDU) comprising a NULL frame and one or more MAC protocol data units (MPDUs), wherein the NULL frame has MAC information that applies to the one or more MPDUs. At 1504, the AP outputs the A-MPDU for transmission. In some cases, the MAC information in the NULL frame may also be conveyed in a MAC header of one or more of the MPDUs. In other cases, the MAC information in the NULL frame may only be conveyed in the NULL frame and not in a MAC header of any of the MPDUs.

As illustrated in FIG. 16, according to certain aspects, the common MAC information may be included in a QoS Null frame as the first frame of the A-MPDU. In some cases, the QoS Null frame may contain only the common MAC information. The common MAC information may subsequently be removed from one or more of the MPDUs that are included in the one or more of the A-MPDUs that are transmitted during the TXOP.

In certain cases, regardless of how common MAC information is delivered (e.g., in a PHY header or QoS NULL frame), this may allow only a limited number of fields to be included in the MPDUs to which it applies as certain fields of the MPDUs contain unique information that is related to the particular MPDU. For example, the limited number of fields may include the Sequence Control field, the payload, and the FCS fields at the end.

Rather than wrapping control information into a data frame, in some cases, data may be wrapped in a control frame. According to certain aspects, data may be included in the FC field. For example, an apparatus may generate and transmit a control frame based on a control frame format and include data in at least one field (e.g., the FC field) of the control frame, wherein the at least one field is not specified in the control frame format.

### Example Indication of GCMP/CCMP Protection of One or More of the Subfields of the HE Control Field

When control information is transmitted as a separate control frame the control information is not protected, i.e., it is not encrypted with CCMP or GCMP. However, in multiple cases it is desirable to encrypt the control information so that only the intended receiver is able to decrypt the control information. A wrapped control and data frame enables to do so, because one or more of the subfields of the control field embedded in the data frame (e.g., one or more of the subfields of the HE control field) may be protected by encrypting it together with the payload of the Data frame (i.e., the MIC field included in the frame covers the one or more of the subfields of the HE Control field). Alternatively, the wrapped control information may not be encrypted with CCMP or GCMP while the Payload of the frame is protected (i.e., the MIC field of the frame does cover only the Payload of the frame. According to certain aspects, the control information may be included in additional authentication data (AAD). However, certain parts of the control information may be masked out of the AAD. AAD, for example, may be taken from a MAC header and included in a Cipher Block Chaining-Message Authentication Code Protocol (CCMP) encryption process.

According to certain aspects, signaling in the control field may indicate whether the one or more of the subfields of the control field (e.g., the HE Control field is or is not encrypted together with the payload of the frame that includes the control field (e.g., together with the payload of the Data frame). FIG. 12 illustrates example fields of a frame control field of a control frame that is included in a wrapped PV1 frame as part of the HE control field, in accordance with certain aspects of the present disclosure. According to certain aspects, the Protected Frame field in the Frame Control field included in HE Control field in the wrapped frame may indicate that one or more of the subfields of the HE Control field are encrypted together with the Payload of the frame. For example, as illustrated, if the value of the Protected Frame field is set to one it indicates that these subfields are encrypted while when set to 0 it indicates that they are not encrypted (even though the payload of the frame itself may be encrypted.

In some cases, protecting the control information in this manner (e.g., via CCMP or GCMP encryption offered by the frame to which the control information is wrapped to) may help prevent faking one or more of the fields of control frames.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 1000 illustrated in FIG. 10, operations 1100 illustrated in FIG. 11, operations 1300 illustrated in FIG. 13, and operations 1500 illustrated in FIG. 15, correspond to means 1000A illustrated in FIG. 10A, means 1100A illustrated in FIG. 11A, means 1300A illustrated in FIG. 13A, and means 1500A illustrated in FIG. 15A, respectively.

For example, means for receiving (or means for obtaining) may comprise a receiver (e.g., the receiver unit of transceiver 254) and/or an antenna(s) 252 of the user terminal 120 illustrated in FIG. 2 or the receiver (e.g., the receiver unit of transceiver 222) and/or antenna(s) 224 of access point 110 illustrated in FIG. 2. Means for transmitting (or outputting for transmission) may be a transmitter (e.g., the transmitter unit of transceiver 254) and/or an antenna(s) 252 of the user terminal 120 illustrated in FIG. 2 or the transmitter (e.g., the transmitter unit of transceiver 222) and/or antenna(s) 224 of access point 110 illustrated in FIG. 2.

Means for processing, means for generating, means for obtaining, means for including, means for outputting, means for detecting, and means for identifying may comprise a processing system, which may include one or more processors, such as the RX data processor 270, the TX data processor 288, and/or the controller 280 of the user terminal illustrated in FIG. 2 or the TX data processor 210, RX data processor 242, and/or the controller 230 of the access terminal 210 illustrated in FIG. 2.

According to certain aspects, such means may be implemented by processing systems configured to perform the corresponding functions by implementing various algorithms (e.g., in hardware or by executing software instructions) described above for providing an immediate response indication in a PHY header. For example, an algorithm for generating a data frame based on a compressed data frame format, an algorithm for including control information in at least one field of the data frame that is not specified in the compressed data frame format, and an algorithm for outputting the data frame for transmission. In another example, an algorithm for generating a frame having a first one or more bits indicating whether the frame has a compressed format and a second one or more bits indicating which of one or more fields are absent if the frame has a compressed format and an algorithm for outputting the frame for transmission. A receiving device may detect (based on one or more bits) that a frame is of a compressed frame format, identify missing fields, process the frame and (generate and) transmit a response acknowledging the compressed frame.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for generating a first frame having a PHY header and a MAC payload, instructions for providing an indication in the PHY header of the first frame, that a response frame to the first frame is to be sent within a time period, and instructions for outputting the first frame for transmission. In another example, instructions for obtaining a first frame having a PHY header and a MAC payload and instructions for determining, based on an indication provided in the PHY header of the first frame, that a response frame to the first frame is to be sent within a time period.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1-17. (canceled)

18. An apparatus for wireless communications, comprising:
a processing system configured to generate a frame having a physical layer (PHY) header and one or more media access control (MAC) protocol data units (MPDUs), wherein the PHY header has MAC information that applies to the one or more MPDUs; and
an interface configured to output the frame for transmission.

19. The apparatus of claim 18, wherein the PHY header comprises at least one signal field including the MAC information therein.

20. The apparatus of claim 19, wherein the at least one signal field further includes an indication of whether the one or more MPDUs comprise an aggregated MPDU (A-MPDU).

21. The apparatus of claim 18, wherein the MAC information is not included in one or more MAC headers of the one or more MPDUs.

22. An apparatus for wireless communications, comprising:
a processing system configured to generate an aggregated media access control (MAC) protocol data unit (A-MPDU) comprising a NULL frame and one or more MAC protocol data units (MPDUs), wherein the NULL frame has MAC information that applies to the one or more MPDUs; and
an interface configured to output the frame for transmission.

23. The apparatus of claim 22, wherein the MAC information comprises at least one of one or more address fields or a duration field.

24. The apparatus of claim 22, wherein the MAC information is also included in one or more MAC headers of the one or more MPDUs.

25-80. (canceled)

81. An access point, comprising:
a processing system configured to generate a frame having a physical layer (PHY) header and one or more media access control (MAC) protocol data units (MPDUs), wherein the PHY header has MAC information that applies to the one or more MPDUs; and
a transmitter configured to transmit the frame.

82. The apparatus of claim 22, further comprising a transmitter configured to transmit the frame, wherein the apparatus is configured as an access point.
